(19) United States
(12) Patent Application Publication
(10) Pub. No.: US 2015/0098042 A1
(43) Pub. Date: Apr. 9, 2015

(54) LIQUID CRYSTAL DISPLAY DEVICE

(71) Applicant: Japan Display Inc., Minato-ku (JP)

(72) Inventor: Jin HIROSAWA, Minato-ku (JP)

(73) Assignee: Japan Display Inc., Minato-ku (JP)

(21) Appl. No.: 14/504,546

(22) Filed: Oct. 2, 2014

(30) Foreign Application Priority Data
Oct. 4, 2013 (JP) 2013-209237

(51) Int. Cl. G02F 1/1362; G02F 1/1333

(52) U.S. Cl. CPC G02F 1/136286; G02F 1/133345; G02F 1/136213; G02F 1/136277
USPC 349/47

(57) ABSTRACT

A liquid crystal display device includes a first substrate, a second substrate and a liquid crystal layer held therebetween. In the first substrate, first and second semiconductor layers are arranged apart from each other. A gate line is arranged on an insulating film extending in a first direction so as to cross the first semiconductor layer. A source line extends in a second direction and contacts the first semiconductor layer. A connection portion is arranged extending in the second direction for electrically coupling the first semiconductor layer and the second semiconductor layer. A main common electrode is arranged extending in the second direction so as to face the source line. A pixel electrode passes a region facing the connection portion and extending in the second direction so as to be apart from the main common electrode. The pixel electrode is electrically coupled to the connection portion.

### CROSS-REFERENCE TO RELATED APPLICATION

This application is based upon and claims the benefit of priority from prior Japanese Patent Application No. 2013-209237 filed Oct. 4, 2013, the entire contents of which are incorporated herein by reference.

### FIELD

Embodiments described herein relate generally to a liquid crystal display device.

### BACKGROUND

In recent years, a liquid crystal display device using lateral electric field, such as IPS (In-Plane Switching) mode and FFS (Fringe Field Switching) mode is developed in an active matrix type liquid crystal display device equipped with a switching element in each pixel. The liquid crystal display device using the lateral electric field mode is equipped with a pixel electrode and a common electrode formed in an array substrate, respectively. Liquid crystal molecules are switched by the lateral electric field substantially in parallel with a principal surface of the array substrate.

On the other hand, another technique is also proposed, in which the liquid crystal molecules are switched using the lateral electric field or an oblique electric field between the pixel electrode formed in the array substrate and the common electrode formed in a counter substrate. As one example, the array substrate includes a common electrode different from the common electrode in the counter substrate and facing a source line so as to shield electric field from the source line.

### BRIEF DESCRIPTION OF THE DRAWINGS

The accompanying drawings, which are incorporated in and constitute a portion of the specification, illustrate embodiments of the invention, and together with the general description given above and the detailed description of the embodiments given below, serve to explain the principles of the invention.

FIG. 1 is a figure schematically showing a structure and an equivalent circuit of a liquid crystal display device according to one embodiment.

FIG. 2 is a plan view schematically showing a structure of one pixel PX when an array substrate AR shown in FIG. 1 is seen from a counter substrate side according to the embodiment.

FIG. 3 is an exploded perspective view schematically showing a main layer structure forming the array substrate AR shown in FIG. 2.

FIG. 4A is a plan view schematically showing a structure of one pixel PX in the counter substrate CT shown in FIG. 1.

FIGS. 4B and 74C are figures showing polarizing axes.

FIG. 5 is a cross-sectional view schematically showing the structure of the liquid crystal display panel LPN taken along line A-B shown in FIG. 2.

FIG. 6 is a cross-sectional view schematically showing the structure of the liquid crystal display panel LPN taken along line C-D shown in FIG. 2.

FIG. 7 is a cross-sectional view schematically showing the structure of the liquid crystal display panel LPN taken along line E-F shown in FIG. 2.

FIG. 8 is a cross-sectional view schematically showing a modified structure of the liquid crystal display panel LPN taken along line A-B shown in FIG. 2 according to a second embodiment.

### DETAILED DESCRIPTION

A liquid crystal display device according to an exemplary embodiment of the present invention will now be described with reference to the accompanying drawings wherein the same or like reference numerals designate the same or corresponding portions throughout the several views.

According to one embodiment, a liquid crystal display device comprises: a first substrate including; a first semiconductor layer, a second semiconductor layer apart from the first semiconductor layer, a first insulating film covering the first semiconductor layer and the second semiconductor layer, a gate line arranged on the first insulating film and extending in a first direction so as to cross the first semiconductor layer, a second insulating film covering the gate line, a source line arranged on the second insulating film and extending in a second direction orthogonally crossing the first direction, the source line contacting the first semiconductor layer, a first contact portion formed in an island shape on the second insulating film and contacting the first semiconductor layer, a second contact portion formed in an island shape on the second insulating film and contacting the second semiconductor layer, a third insulating film covering the source line, the first contact portion and the second contact portion, a connection portion arranged on the third insulating film and extending in the second direction for electrically coupling the first contact portion and the second contact portion, the connection portion being formed of transparent conductive material, a sub-common electrode arranged on the third insulating film and extending in the first direction, the sub-common electrode facing the gate line and crossing the source line, a first main common electrode arranged on the third insulating film and electrically coupled with the sub-common electrode so as to extend in the second direction along the source line, a fourth insulating film covering the connection portion, the sub-common electrode and the first main common electrode, a second main common electrode arranged on the fourth insulating film and extending in the second direction so as to face the source line, the second main common electrode being set to the same potential as the first main common electrode, and a pixel electrode including a main pixel electrode arranged on the fourth insulating film, passing a region facing the connection portion and extending in the second direction so as to be apart from the second main common electrode, the pixel electrode being electrically coupled to the connection portion, and a first alignment film covering the second main common electrode and the pixel electrode, a second substrate facing the first substrate; and a liquid crystal layer held between the first substrate and the second substrate.

According to other embodiment, a liquid crystal display device comprises: a first substrate including; a first semiconductor layer, a second semiconductor layer apart from the first semiconductor layer, a first insulating film covering the first semiconductor layer and the second semiconductor layer, a gate line arranged on the first insulating film and extending in a first direction so as to cross the first semiconductor layer, a second insulating film covering the gate line, a source line arranged on the second insulating film and extending in a second direction orthogonally crossing the first direction, the source line contacting the first semiconductor layer, a third insulating film covering the source line, a connection portion arranged on the third insulating film and extending in the second direction for electrically coupling the first semiconductor layer and the second semiconductor layer, a fourth insulating film covering the connection portion, a main common electrode arranged on the fourth insulating film and extending in the second direction so as to face the source line, a pixel electrode including a main pixel electrode arranged on the fourth insulating film, passing a region facing the connection portion and extending in the second direction so as to be apart from the main common electrode, the pixel electrode being electrically coupled to the connection portion, and a first alignment film covering the main common electrode and the pixel electrode, a second substrate facing the first substrate; and a liquid crystal layer held between the first substrate and the second substrate.

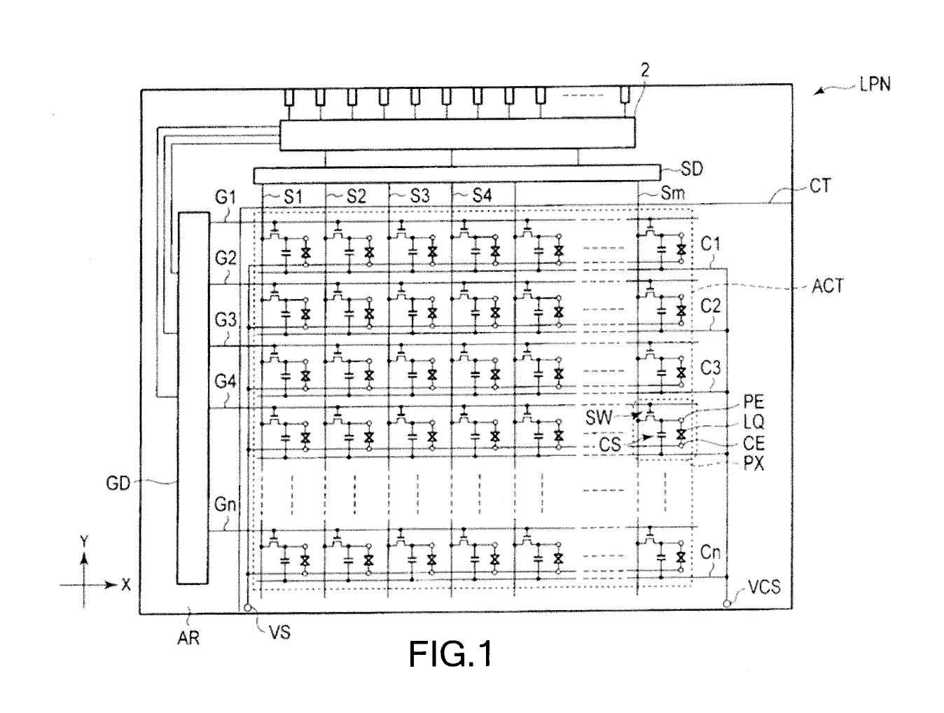

FIG. 1 is a figure schematically showing a structure and the equivalent circuit of a liquid crystal display device according to one embodiment.

The liquid crystal display device includes an active-matrix type liquid crystal display panel LPN. The liquid crystal display panel LPN is equipped with an array substrate AR as a first substrate, a counter substrates CT as a second substrate arranged opposing the array substrate AR, and a liquid crystal layer LQ held between the array substrate AR and the counter substrate CT. The liquid crystal display panel LPN includes an active area ACT which displays images. The active area ACT is formed of a plurality of pixels PX arranged in a matrix shape.

The liquid crystal display panel LPN is equipped with a plurality of gate lines G (G1-Gn), a plurality of storage capacitance lines C (C1-Cn), source lines S (S1-Sm), etc., in the active area ACT. The gate line G and the storage capacitance line C linearly extend in a first direction X, respectively. The gate line G and the storage capacitance line C are arranged in turns at intervals along a second direction Y that orthogonally intersects the first direction X. The source lines S linearly extend in the second direction Y, respectively. The source lines S cross the gate line G and the capacitance line C. The gate line G, the storage capacitance line C and the source lines S may not necessarily extend linearly, and a portion thereof may be crooked partly.

Each gate line G is pulled out to outside of the active area ACT, and connected to a gate driver GD. Each source line S is pulled out to the outside of the active area ACT, and connected to a source driver SD. At least portions of the gate driver GD and the source driver SD are formed in the array substrate AR, for example. The gate driver GD and the source driver SD are connected with a driver IC chip 2 provided in the array substrate AR and having an implemented controller.

Each pixel PX includes a switching element SW, a pixel electrode PE, a common electrode CE, etc. Storage capacitance CS is formed, for example, between the storage capacitance line C and the pixel electrode PE. The storage capacitance line C is electrically connected with a voltage impressing portion VCS to which storage capacitance voltage is impressed.

The switching element SW is formed of an n channel type thin film transistor (TFT), for example. The switching element SW is electrically connected with the gate line G and the source line S. The switching element SW may be either a top-gate type or a bottom-gate type. Though the semiconductor layer of the switching element SW is formed of poly-silicon in this embodiment, the semiconductor layer may be formed of amorphous silicon.

The pixel electrode PE is arranged in each pixel PX and electrically connected with the switching element SW. The common electrode CE of common potential is arranged in common to the plurality of pixel electrodes PE interposing the liquid crystal layer LQ. For example, an electric power supply portion VS is formed outside of the active area ACT in the array substrate AR. Furthermore, the common electrode CE is drawn to outside of the active area ACT and electrically connected with the electric power supply portion VS.

In addition, in the liquid crystal display panel LPN according to this embodiment, the pixel electrode PE is formed in the array substrate AR, and at least a portion of the common electrode CE is also formed in the array substrate AR. Liquid crystal molecules of the liquid crystal layer LQ are switched mainly using electric field formed between the pixel electrode PE and the common electrode CE. The electric field formed between the pixel electrode PE and the common electrode CE is an oblique electric field slightly oblique with respect to a X-Y plane specified by the first direction X and the second direction Y, i.e., the substrates (or lateral electric field substantially in parallel with the principal surface of the substrate.)

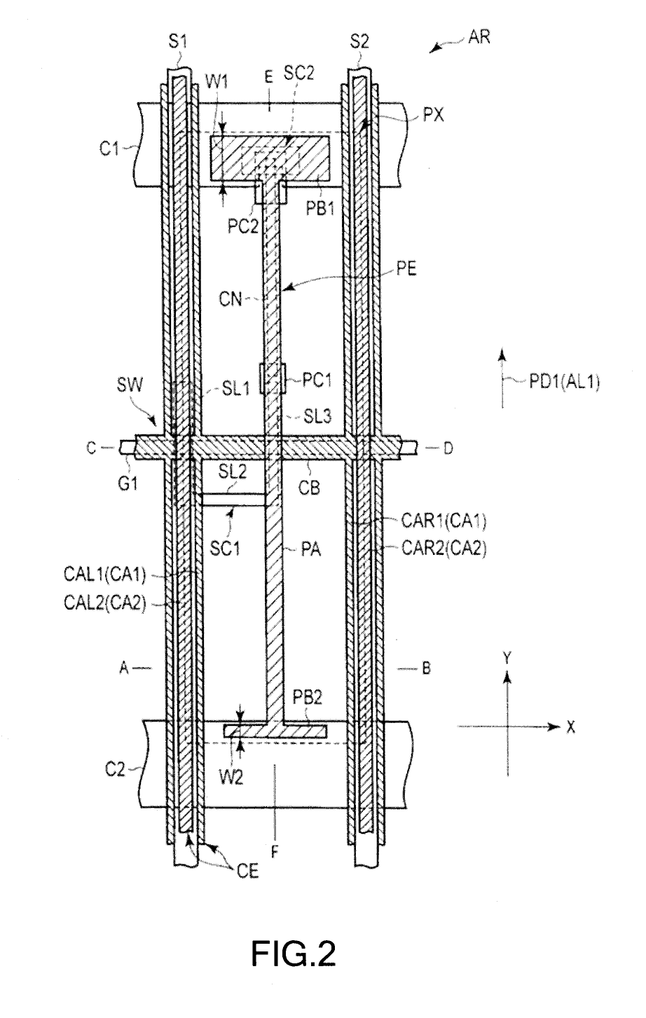

FIG. 2 is a plan view schematically showing a structure of one pixel when the array substrate AR shown in FIG. 1 is seen from the counter substrate side according to a first embodiment. Herein, a plan view in the X-Y plane is shown.

The array substrate AR is equipped with a first semiconductor layer SC1, a second semiconductor layer SC2, a first contact portion PC1, a second contact portion PC2, a connection portion CN, a gate line G1, an storage capacitance line C1, an storage capacitance line C2, a source line S1, a source line S2, a switching element SW, a pixel electrode PE, a portion of a common electrode CE, and a first alignment film AL1, etc.

The storage capacitance line C1 and the storage capacitance line C2 are arranged at intervals along the second direction Y, and extend in the first direction X, respectively. The gate line G1 is located between the storage capacitance line C1 and the storage capacitance line C2, and extend along the first direction X. In this embodiment, the gate line G1 is located in an approximately center between the storage capacitance line C1 and the storage capacitance line C2. That is, the interval between the gate line G1 and the storage capacitance line C1 in the second direction Y is approximately the same as the interval between the gate line G1 and the storage capacitance line C2 in the second direction Y. The source line S1 and the source line S2 are arranged at intervals along the first direction X, and extend in the second direction Y, respectively. The pixel electrode PE is arranged between the adjoining source line S1 and source line S2.

In this embodiment, the pixel PX corresponds to a square region surrounded with the storage capacitance lines C1 and C2 and the source lines S1 and S2, and is formed in a rectangular shape whose length in the first direction X is shorter than the length in the second direction Y, as shown with a dashed line in FIG. 2. The length in the first direction X of the pixel PX corresponds to a pitch between the source line S1 and the source line S2 in the first direction X, and the length in the second direction Y of the pixel PX corresponds to a pitch between the storage capacitance C1 and the storage capacitance line C2 in the second direction Y.

In the illustrated pixel PX, the source line S1 is arranged at the left-hand side end in the pixel PX. Precisely, the source line S1 is arranged striding over a boundary between the illustrated pixel PX and a pixel adjoining the illustrated pixel PX on the left-hand side. The source line S2 is arranged at the right-hand side end. Similarly, the source line S2 is arranged striding over a boundary between the illustrated pixel PX and a pixel adjoining the illustrated pixel PX on the right-hand side. Moreover, in the pixel PX, the storage capacitance line C1 is arranged in an upper end portion. Precisely, the storage capacitance line C1 is arranged striding over a boundary between the illustrated pixel PX and a pixel adjoining the illustrated pixel PX on its upper end side. The storage capacitance line C2 is arranged in a lower end portion. Precisely, the storage capacitance line C2 is arranged striding over a boundary between the illustrated pixel PX and a pixel adjoining the illustrated pixel PX on its lower end side. The gate line G1 is arranged approximately in a central portion of the pixel PX.

The switching element SW is electrically connected with the gate line G1 and the source line S1. In the switching element SW, the first semiconductor layer SC1 is formed in a U shape, and includes a first straight line portion SL1, a second straight line portion SL2, and a third straight line portion SL3. The first straight line portion SL1 extends in the second direction Y, and counters the source line S1. The first straight line portion SL1 contacts the source line S1 in its one end portion, and intersects the gate line G1. The second straight line portion SL2 is connected with the other end portion of the first straight line portion SL1, and extends in a region between the gate line G1 and the storage capacitance line C2, and also between the source line S1 and the pixel electrode PE in the first direction X. The third straight line portion SL3 is connected with the second straight line portion SL2 in its one end portion, and extends in the second direction Y intersecting the gate line G1. The other end portion of the third straight line portion SL3 is in contact with the first contact portion PC1.

Moreover, in the switching element SW, the second semiconductor layer SC2 is arranged apart from the first semiconductor layer SC1, and located on the same straight line as the third straight line portion SL3 in the second direction Y. In this embodiment, the second semiconductor layer SC2 is arranged in a position which counters the storage capacitance line C1. The second semiconductor layer SC2 is in contact with a second contact portion PC2.

The connection portion CN extends in the second direction Y, and is located on the same straight line as the third straight line portion SL3. The connection portion CN electrically connects the first contact portion PC1 and the second contact portion PC2.

The pixel electrode PE is electrically connected with the second contact portion C2 in a position which overlaps with the storage capacitance line C1. The pixel electrode PE is equipped with a main pixel electrode PA, a first sub-pixel electrode PB1, and a second sub-pixel electrode PB2. The main pixel electrodes PA, the first sub-pixel electrode PB1, and the second sub-pixel electrode PB2 are formed integrally or continuously, and electrically connected mutually.

The main pixel electrode PA is located between the source line S1 and the source line S2, and linearly extends to the circumference of an upper end and a bottom end of the pixel PX along the second direction Y. In this embodiment, the main pixel electrode PA is located in an approximately center between the source line S1 and the source line S2. That is, the interval between the source line S1 and the main pixel electrode PA in the first direction X is approximately the same as the interval between the source line S2 and the main pixel electrode PA. The main pixel electrode PA is formed in a stripe shape with substantially the same width along the first direction X. The main pixel electrode PA passes a region which counters the third straight line portion SL3 and the connection portion CN, and extends in the second direction Y.

The first sub-pixel electrode PB1 lineally extends between the source line S1 and the source line S2 along the first direction X. The first sub-pixel electrode PB1 is connected with an end portion of the main pixel electrode PA, and located in a region which overlaps with the storage capacitance line C1 so as to be eccentrically-located on the gate line G1 side. Moreover, at least a portion of the first sub-pixel electrode PB1 overlaps with the connection portion CN, and is electrically connected with the connection portion CN. The first sub-pixel electrode PB1 is formed in a stripe shape with substantially the same width W1 along the second direction Y.

The second sub-pixel electrode PB2 lineally extends between the source line S1 and the source line S2 along the first direction X. The second sub-pixel electrode PB2 is connected with the other end portion of the main pixel electrode PA, and located in a region which overlaps with the storage capacitance line C2 so as to be eccentrically-located on the gate line G1 side. The second sub-pixel electrode PB2 is formed in a stripe shape with substantially the same width W2 along the second direction Y.

Although not illustrated, one storage capacitance line is arranged striding over two pixels which adjoin in the second direction Y, mutually. The first sub-pixel electrode PB1 of the pixel electrode in one pixel and the second sub-pixel electrode PB2 in the adjacent pixel in the second direction Y are arranged at intervals in the region which overlaps with the storage capacitance line. While the first sub-pixel electrode PB1 is formed broadly to secure an area required for contacting with the connection portion CN, the second sub-pixel electrode PB2 may function as an electrode for forming electric field. For this reason, the width W1 of the first sub-pixel electrode PB1 is larger than the width W2 of the second sub-pixel electrode PB2.

The common electrode CE is equipped with a first main common electrode CA1, a second main common electrode CA2, and a sub-common electrode CB. The first main common electrode CA1 and the sub-common electrode CB are formed integrally or continuously, and electrically connected mutually. While the second main common electrode CA2 is arranged apart from the first main common electrode CA1, etc., the second main common electrode CA2 and the first main common electrode CA1 are electrically connected mutually. That is, the first main common electrode CA1 and the second main common electrode CA2 are connected with the electric power supply portion VS in the outside of the active area ACT, and set to the same potential each other.

The first main common electrode CA1 extends along the source line S. The first main common electrode CA1 is located on the both sides sandwiching the main pixel electrode PA in the X-Y plane, and linearly extends along the second direction Y. The first main common electrode CA1 is arranged on the pixel electrode PE side rather than the position which overlaps with the source line S. That is, the first main common electrode CA1 is arranged on the both sides sandwiching one source line. The first main common electrode CA1 is formed in a stripe shape with the same width along the first direction X.

In this embodiment, the first main common electrode CA1 is arranged in two parallel lines at intervals in the first direction X, and is equipped with a first main common electrode CAL1 located in the left-hand side end, and a first main common electrode CAR1 located in the right-hand side end of the pixel PX. While the first main common electrode CAL1 extends along the source line S1 and is arranged on the pixel electrode PE side rather than the position which overlaps with the source line S1, a portion thereof may be arranged overlapping with the source line S1. Similarly, while the first main common electrode CAR1 extends along the source line S2 and is arranged on the pixel electrode PE side rather than the position which overlaps with the source line S2, a portion thereof may be arranged overlapping with the source line S2.

The sub-common electrode CB faces the gate line G1. That is, the sub-common electrode CB linearly extends along the first direction X in the X-Y plane. The sub-common electrode CB is formed in a stripe shape with substantially the same electrode width in the second direction Y. The electrode width of the sub-common electrode CB along the second direction Y is larger than the width of the gate line G1 in the second direction Y, for example. That is, while the sub-common electrode CB is arranged so as to overlap with the gate line G1, the sub-common electrode CB is arranged so as to extend a little toward the storage capacitance lines C1 and C2 beyond the position which overlaps with the gate line G1. The sub-pixel electrode CB is connected with the first main common electrode CAL1 on the left end side of the pixel PX, and the first main common electrode CAR1 on the right end side of the pixel PX.

The second main common electrode CA2 counters the source line S. That is, the second main common electrode CA2 is located on the both sides sandwiching the main pixel electrode PA in the X-Y plane, and linearly extends along the second direction Y. The second main common electrode CA2 extends substantially in parallel to the first main common electrode CA1. The second main common electrode CA2 is formed in the shape of a stripe with a smaller width than the width of the source line S and substantially the same width along the first direction X.

In this embodiment, the second main common electrode CA2 is arranged in two parallel lines at intervals in the first direction X, and includes a second main common electrode CAL2 located on the left-hand side of the pixel PX and arranged striding over a boundary between the illustrated pixel PX and a pixel adjoining the illustrated pixel PX on the left-hand side, and a second main common electrode CAR2 located on the right-hand side of the pixel PX and arranged striding over a boundary between the illustrated pixel PX and a pixel adjoining the illustrated pixel PX on the right-hand side. The second main common electrode CAL2 extends in parallel with the first main common electrode CAL1 with a smaller width than the width of the source line S1, and is arranged in a location overlapping with the source line S1. The second main common electrode CAL2 crosses the sub-common electrode CB on the source line S1. Further, the second main common electrode CAR2 extends in parallel to the first main common electrode CAR1 with a smaller width than the width of the source line S2, and is arranged in a location overlapping with the source line S2 so as to cross the sub-common electrode CB on the source line S2.

In the array substrate AR, the pixel electrode PE and the second main common electrode CA2 are covered with the first alignment film AL1. Alignment treatment is carried out to the first alignment film AL1 along with an alignment treatment direction PD1 to initially align liquid crystal molecules of the liquid crystal layer LQ. The alignment treatment direction PD1 is substantially in parallel to the second direction Y, for example.

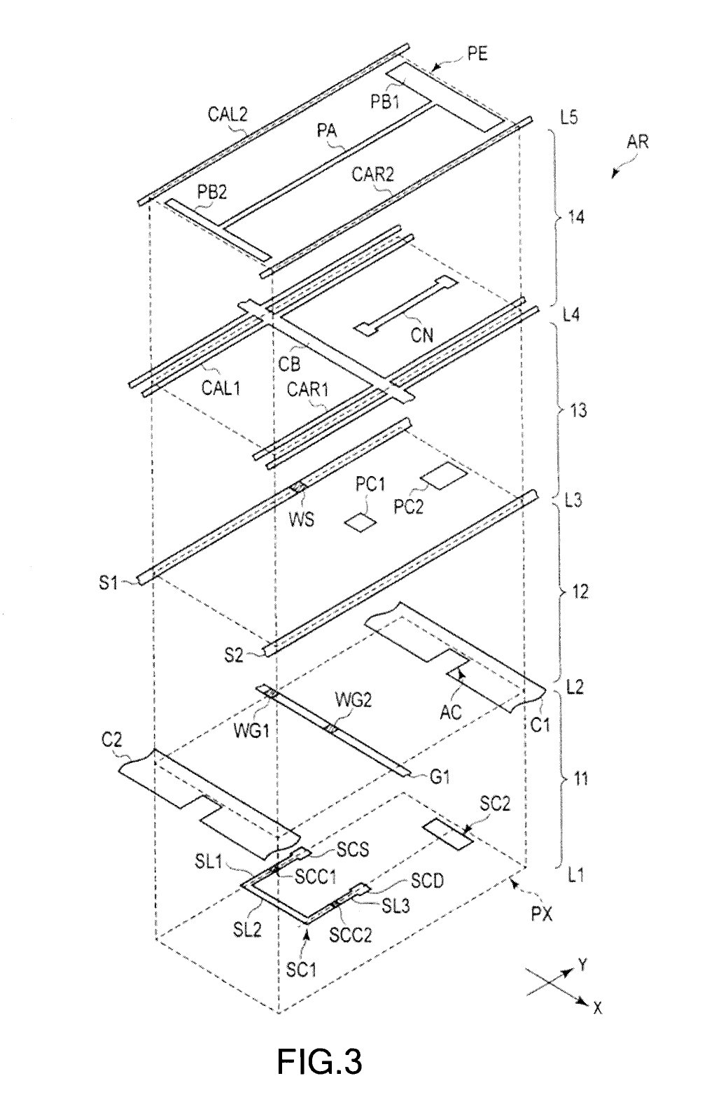

FIG. 3 is an exploded perspective view schematically showing a main layer structure forming the array substrate AR shown in FIG. 2. In addition, the main electric conductive layers in the array substrate AR are illustrated herein.

A first insulating film 11 is interposed between a first layer L1 and a second layer L2, a second insulating film 12 is interposed between the second layer L2 and a third layer L3, a third insulating film 13 is partly interposed between the third layer L3 and a fourth layer L4, and a fourth insulating film 14 is interposed between the fourth layer L4 and a fifth layer L5.

In this embodiment, the switching element is formed with a double-gate structure in which two switching elements are series connected. The first semiconductor layer SC1 and the second semiconductor layer SC2 of the switching element are arranged in the first layer L1. For example, the first semiconductor layer SC1 and the second semiconductor layer SC2 are formed with poly-silicon. The first straight line portion SL1 of the first semiconductor layer SC1 passes under the source line S1 and intersects the gate line G1. A region of the first straight portion SL1 of the first semiconductor layer SC1 located under the gate line G1 forms a channel region SCC1 of a first switching element. A region in which the first semiconductor layer SC1 extends from the channel region SCC1 and contacts with the source line S1 forms a source region SCS of the first switching element. The third straight line portion SL3 passes under the main pixel electrode PA, and intersects the gate line G1. A region located right under the gate line G1 in the third straight line portion SL3 is equivalent to a channel region SCC2 of a second switching element. A region in which the channel region SCC2 extends and contacts the first contact portion PC1 is equivalent to a drain region SCD of the second switching element. The second straight line portion SL2 is connected between one end of the first straight line portion SL1 located on an opposite side to the contact portion with the source line S1 sandwiching the channel region SCC1 and one end of the third straight line portion SL3 located on an opposite side to the contact portion with the first contact portion PC1 sandwiching the channel region SCC2. The second straight line portion SL2 extends in parallel to the gate line G1 in the first direction. The second semiconductor layer SC2 is arranged apart from first semiconductor layer SC1, and located under the storage capacitance line C1. That is, the first semiconductor layer SC1 and second semiconductor layer SC2 are broken off right under the main pixel electrode PA.

In the second layer L2, the storage capacitance line C1, the gate line G1, and the storage capacitance line C2 are arranged. The storage capacitance line C1 is located above a portion of the second semiconductor layer SC2 and extends in the first direction X. An aperture portion (cutting out portion) AC is formed in the storage capacitance line C1 facing the second semiconductor layer SC2. In the gate line G1, a region located above the first straight line portion SL1 is equivalent to a gate electrode WG1 of the first switching element, and the region located above the third straight line portion SL3 is equivalent to a gate electrode WG2 of the second switching element.

In the third layer L3, the source line S1, the source line S2, the first contact portion PC1 and the second contact portion PC2 are arranged. The source line S1 is located above the first straight line portion SL1 and extends in the second direction Y. In the source line S1, a region which contacts the first straight line portion SL1 corresponds to a source electrode WS of the first switching element. That is, the source electrode WS is in contact with the source region SCS through a contact hole which penetrates the first insulating film 11 and the second insulating film 12. The first contact portion PC1 is located above a drain region SCD of the second switching element in the third straight line portion SL3. The first contact portion PC1 corresponds to the drain electrode of the second switching element. That is, the first contact portion PC1 is in contact with the drain region SCD through the contact hole which penetrates the first insulating film 11 and the second insulating film 12. The second contact portion PC2 is located above the storage capacitance line C1. The second contact portion PC2 is in contact with the second semiconductor layer SC2 through the contact hole which penetrates the first insulating film 11 and the second insulating film 12 via the aperture portion AC.

In the fourth layer L4, the first main common electrode CAL1, the first main common electrode CAR1, the sub-common electrode CB and the connection portion CN are arranged. The first main common electrode CAL1 is located inside of the pixel PX rather than above the source line S1. The first main common electrode CAR1 is located inside of the pixel PX rather than above the source line S2. The sub-common electrode CB is located above the gate line G1. The connection portion CN is located on the storage capacitance line C1 side rather than the sub-common electrode CB side and arranged between the first main common electrode CAL1 and the first main common electrode CAR1. The one end portion of the connection portion CN contacts the first contact portion PC1 through a contact hole which penetrates the third insulating film 13, and the other end portion thereof is in contact with the second contact portion PC2 through a contact hole which penetrates the third insulating film 13.

In the fifth layer L5, the second main common electrode CAL2, the second main common electrode CAR2, and the pixel electrode PE are arranged. The second main common electrode CAL2 is located above the source line S1. The second main common electrode CAR2 is located above the source line S2. While the main pixel electrode PA of the pixel electrode PE faces the connection portion CN interposing the fourth insulating film 14, the main pixel electrode PA intersects the sub-common electrode CB. The first sub-pixel electrode PB1 is located above the first contact portion PC1 and the other end portion of the connection portion CN, and in contact with the connection portion CN through a contact hole which penetrates the fourth insulating film 14. The second sub-pixel electrode PB2 is located above the storage capacitance line C2.

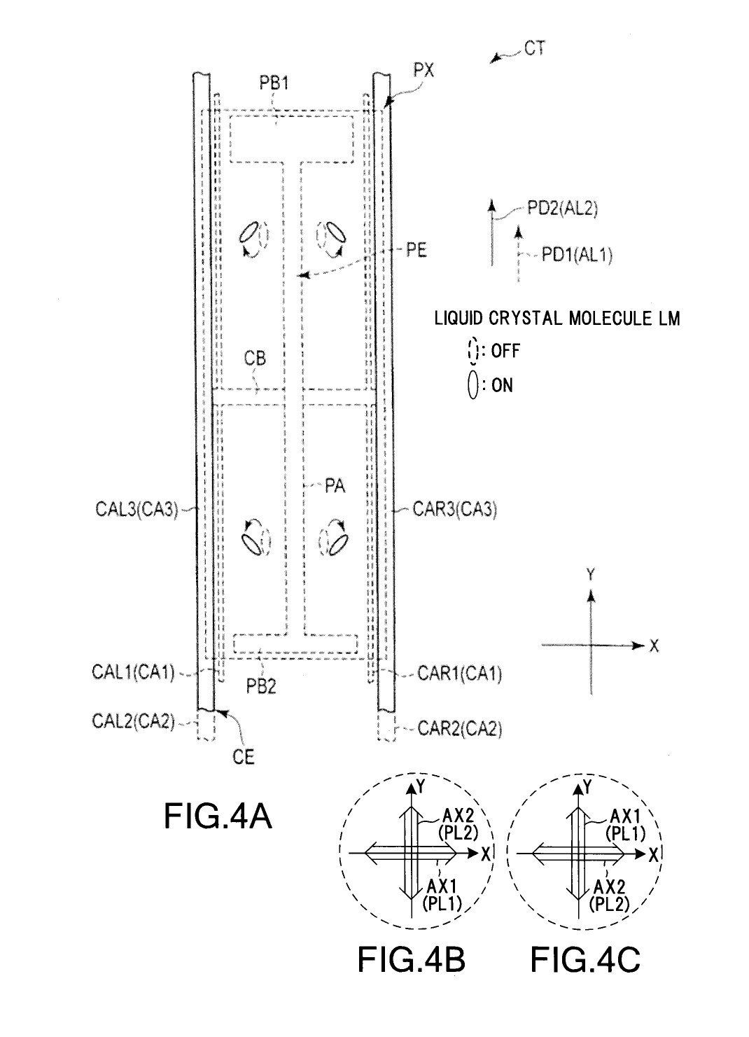

FIG. 4A is a plan view schematically showing a structure of one pixel PX in the counter substrate CT shown in FIG. 1. FIGS. 4B and 4C are figures showing polarizing axes. Herein, the plan view in the X-Y plane is shown. In addition, only structures required for explanation is illustrated, and a dashed line shows portions of the pixel electrodes PE and the common electrodes CE which are principal portions of the array substrate.

The counter substrate CT is equipped with a third main common electrode CA3 which is a portion of the common electrodes CE. The third main common electrode CA3 is electrically connected with the electric power supply portion VS outside of the active area in the array substrate, or electrically connected with the first main common electrode CA1 formed in the array substrate AR. Thereby, the third main common electrode CA3 is set to substantially the same common potential as the first main common electrode CA1, etc.

The third main common electrode CA3 is located on the both sides sandwiching the pixel electrode PE in the X-Y plane, and linearly extends in the second direction Y. The third main common electrode CA3 is located above the second main common electrode CA2. The third main common electrode CA3 is formed in a stripe shape with substantially the same width in the first direction X.

In this embodiment, the third main common electrode CA3 is arranged in two parallel lines at intervals in the first direction X. The third main common electrode CA3 includes a third main common electrode CAL3 striding over a boundary between the illustrated pixel PX and a pixel adjoining on the left-hand side of the illustrated pixel PX, and a third main common electrode CAR3 striding over a boundary between the illustrated pixel PX and a pixel adjoining on the right-hand side of the illustrated pixel PX. The third main common electrode CRL3 counters with the second main common electrode CAL2. The third main common electrode CAR3 counters with the second main common electrode CAR2.

In addition, the common electrode CE may include a second sub-common electrode connected with the third main common-electrode CA3 so as to face the sub-common electrode CB.

In the counter substrate CT, the third main common electrode CA3 is covered with a second alignment film AL2. In the second alignment film AL2, alignment treatment is made along with a second alignment treatment direction PD2 to make the liquid crystal molecule of the liquid crystal layer LQ initial alignment. Herein, the alignment treatment is performed by rubbing treatment, optical alignment treatment, etc., for example. The second alignment treatment direction PD2 is in parallel to the first alignment treatment direction PD1, and the same direction as the first alignment treatment direction PD1 in this embodiment. In addition, the first alignment treatment direction PD1 and the second alignment treatment direction PD2 may be opposite directions each other, or may be the opposite directions to the directions shown in the Figure while they are the same directions each other, i.e., the direction from the first sub-pixel electrode PB1 to the second sub-pixel electrode PB2.

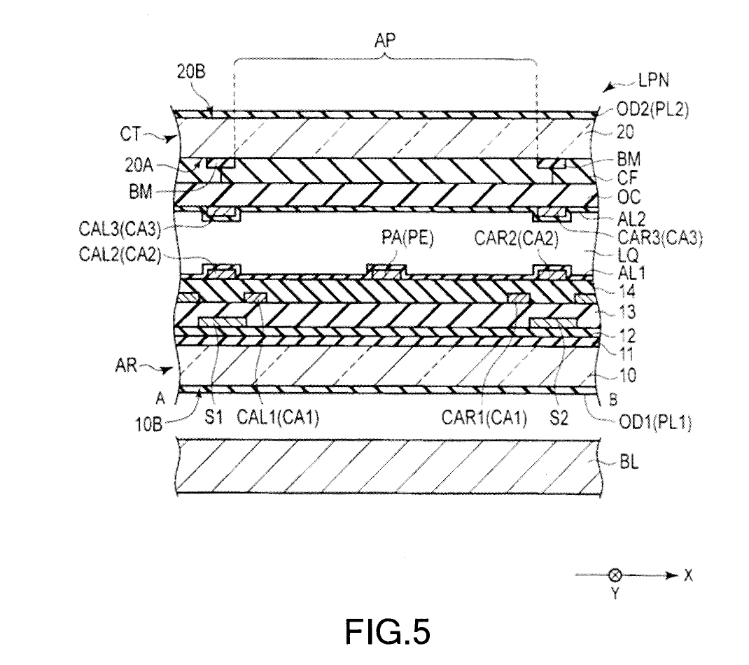

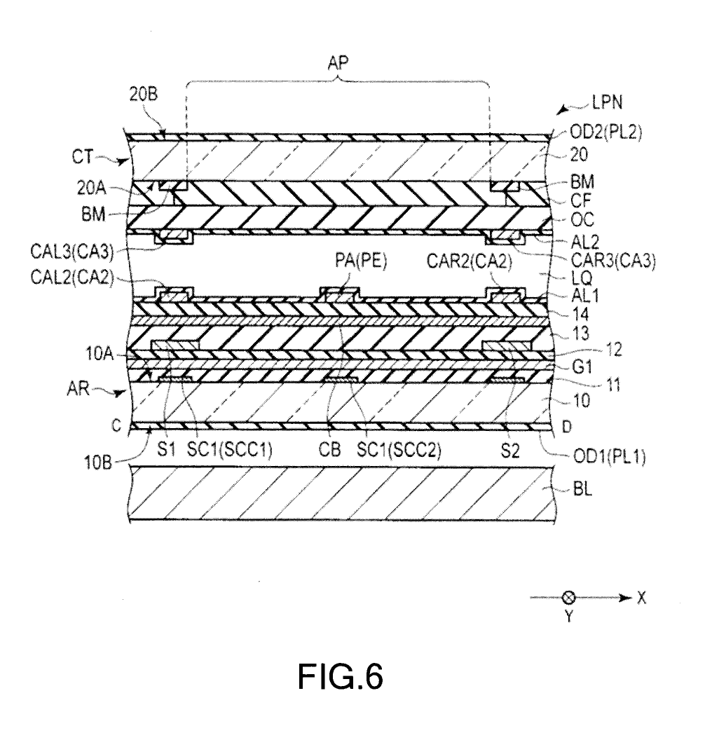

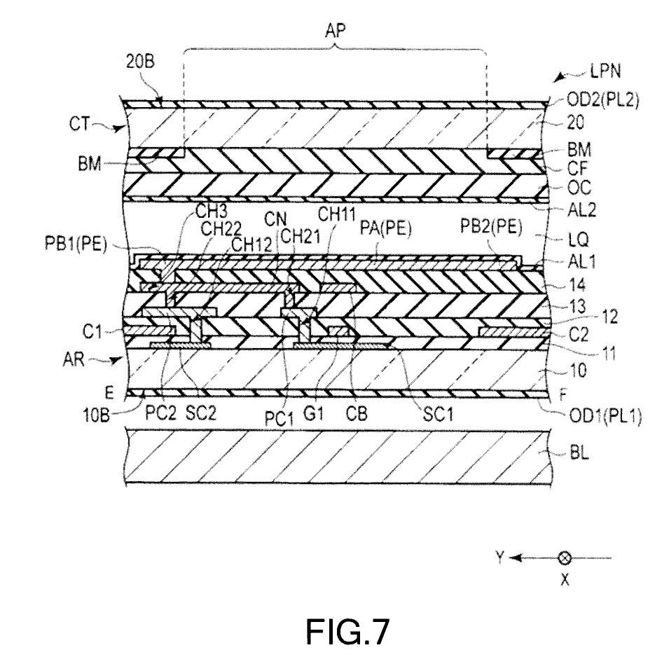

FIG. 5 is a cross-sectional view schematically showing the structure of the liquid crystal display panel LPN taken along line A-B shown in FIG. 2. FIG. 6 is a cross-sectional view schematically showing the structure of the liquid crystal display panel LPN taken along line C-D shown in FIG. 2. FIG. 7 is a cross-sectional view schematically showing the structure of the liquid crystal display panel LPN taken along line E-F shown in FIG. 2.

A backlight BL is arranged on the back side of the array substrate AR in the illustrated example. Though various types of backlights BL can be used, the explanation about its detailed structure is omitted herein.

The array substrate AR is formed using a first transparent insulating substrate 10. The array substrate AR includes the first semiconductor layer SC1 and the second semiconductor layer SC2 forming the switching element, the gate line G1, the storage capacitance line C1, the storage capacitance line C2, the source line S1, the source line S2, the first contact portion PC1, the second contact portion PC2, the connection portion CN, the pixel electrode PE, the first main common electrode CA1, the second main common electrode CA2, the first insulating film 11, the second insulating film 12, the third insulating film 13, the fourth insulating film 14, and the first alignment AL1, etc., in an inside surface of the first transparent insulating substrate 10 facing the counter substrate CT.

The first semiconductor layer SC1 and second semiconductor layer SC2 are formed between the first insulating substrate 10 and the first insulating film 11. The storage capacitance line C1, the storage capacitance line C2, and the gate line G1 are formed on the first insulating film 11, and covered with the second insulating film 12. The storage capacitance lines C1, the storage capacitance line C2, and the gate line G1 can be formed simultaneously by the same wiring material.

The source line S1, the source line S2, the first contact portion PC1 and the second contact portion PC2 are formed on the second insulating film 12 and covered with the third insulating film 13. The source line S1, the source line S2, the first contact portion PC1 and the second contact portion PC2 may be simultaneously formed of the same wiring materials. The first contact portion PC1 is in contact with the first semiconductor layer SC1 through a contact hole CH11 penetrating the first insulating film 11 and the second insulating film 12. The second contact portion PC2 is in contact with the second semiconductor layer SC2 through a contact hole CH12 penetrating the first insulating film 11 and the second insulating film 12.

The first main common electrode CA1, the sub-common electrode CB and the connection portion CN are formed on the third insulating film 13, and covered with the fourth insulating film 14. The first main common electrode CA1, the sub-common electrode CB, and the connection portion CN are formed of transparent electric conductive materials, such as Indium Tin Oxide (ITO) and Indium Zinc Oxide (IZO), for example. The first main common electrode CAL1 is located inside rather than the above portion of the source line S1, and the first main common electrode CAR1 is located inside rather than the above portion of the source line S2. The connection portion CN is in contact with the first contact portion PC1 through a contact hole CH21 which penetrates the third insulating film 13, and also in contact with the second contact portion PC2 through a contact hole CH22 which penetrates the third insulating film 13. That is, the connection portion CN electrically connects the first semiconductor layer SC1 and the second semiconductor layer SC2 apart from each other.

The main pixel electrode PA of the pixel electrode PE, the first sub-pixel electrode PB1, and the second sub-pixel electrode PB2 are formed on the fourth insulating film 14, and covered with the first alignment film AL1. In the pixel electrode PE, the first sub-pixel electrode PB1 is located above the storage capacitance line C1, the first contact portion PC1, or the end of the connection portion CN, and in contact with the connection portion CN through a contact hole CH3 which penetrates the fourth insulating film 14.

Moreover, the second main common electrode CA2 is formed on the fourth insulating film 14 apart from the pixel electrode PE, and covered with the first alignment film AL1. The second main common electrode CAL2 is located above the source line S1, and the second main common electrode CAR2 is located above the source line S2. The pixel electrode PE and the second main common electrode CA2 can be formed simultaneously by the same material, and may be formed of transparent electric conductive materials, such as ITO and IZO, or other opaque wiring materials, such as aluminum (Al), titanium (Ti), silver (Ag), molybdenum (Mo), tungsten (W), copper (Cu), and chromium (Cr).

The first alignment film AL1 is arranged on the array substrate AR facing the counter substrate CT, and extends to whole active area ACT. The first alignment film AL1 is arranged also on the fourth insulating film 14. The first alignment film AL1 is formed of the material which shows a horizontal alignment characteristics.

The counter substrate CT is formed using a second transparent insulating substrate 20. The counter substrate CT includes a black matrix BM, a color filter CF, an overcoat layer OC, a third main common electrode CA3, and a second alignment film AL2, etc., in an internal surface of the second insulating substrate 20 facing the array substrate AR.

The black matrix BM defines each pixel PX, and forms an aperture AP facing the pixel electrode PE. That is, the black matrix BM is arranged so that wiring portions, i.e., the source line S, the storage capacitance line C, and the switching element SW may counter the black matrix BM. Herein, the black matrix BM includes a portion located above the source lines S1 and S2 extending along the second direction Y, and a portion located above the storage capacitance lines C1 and C2 extending along the first direction X, and is formed in the shape of a lattice. The black matrix BM is formed in the internal surface 20A of the second insulating substrate 20 facing the array substrate AR.

The color filter CF is arranged corresponding to each pixel PX. That is, while the color filter CF is arranged in the aperture AP defined by the black matrix in the internal surface 20A of the second insulating substrate 20, a portion thereof extends on the black matrix BM. The colors of the color filters CF arranged in adjacent pixels PX in the first direction X differ mutually. For example, the color filters CF are formed of resin materials colored by three primary colors of red, blue, and green, respectively. The red color filter formed of resin material colored in red is arranged corresponding to the red pixel. The blue color filter formed of resin material colored in blue is arranged corresponding to the blue pixel. The green color filter formed of resin material colored in green is arranged corresponding to the green pixel. The boundary between the adjacent color filters CF is located in a position which overlaps with the black matrix BM. Furthermore, the color filter CF extends to a plurality of adjacent pixels in the second direction Y.

The overcoat layer OC covers the color filter CF. The overcoat layer OC eases influence of concave-convex of the surfaces of the color filter CF and the black matrix BM. The overcoat layer OC is formed of a transparent resin material, for example.

The third main common electrode CA3 is formed on the overcoat layer OC facing the array substrate AR, and located under the black matrix BM. The second main common electrode CAL2 is located under the third main common electrode CAL3. The second main common electrode CAR2 is located under the third main common electrode CAR3. In the above-mentioned aperture AP, the domain between the pixel electrode PE and the second and third main common electrodes CA2 and CA3 corresponds to a transmissive domain which penetrates the backlight.

The second alignment film AL2 is arranged on the counter substrate CT facing the array substrate AR, and extends to whole active area ACT. The second alignment film AL2 covers the third main common electrode CA3, the overcoat layer OC, etc. The second alignment film AL2 is formed of the materials having horizontal alignment characteristics.

The array substrate AR and the counter substrate CT as mentioned-above are arranged so that the first alignment film AL1 and the second alignment film AL2 face each other. In this case, a pillar-shaped spacer is formed integrally with one of the substrates by resin material between the first alignment film AL1 on the array substrate AR and the second alignment film AL2 on the counter substrate CT. Thereby, a predetermined gap, for example, a 2-7 μm cell gap, is formed. The cell gap is smaller than the distance between the main pixel electrode PA and the first main common electrode CA1. The array substrate AR and the counter substrate CT are pasted together by seal material arranged outside the active area ACT, while the predetermined cell gap is formed, for example.

The liquid crystal layer LQ is held in a cell gap formed between the array substrate AR and the counter substrate CT, i.e., between the first alignment film AL1 and the second alignment film AL2. The liquid crystal layer LQ contains liquid crystal molecules LM. For example, the liquid crystal layer LQ is formed of liquid crystal material whose dielectric anisotropy is positive (posi-type).

A first optical element OD1 is attached on an external surface 10B of the array substrate AR, i.e., the external surface of the first insulating substrate 10 which forms the array substrate AR by adhesives, etc. The first optical element OD1 is located on a side which counters with the backlight unit BL of the liquid crystal display panel LPN, and controls the polarization state of the incident light which enters into the liquid crystal display panel LPN from the backlight unit BL. The first optical element OD1 includes a first polarization plate PL1 having a first polarizing axis AX1. Other optical elements such as retardation film may be arranged between the first polarization plate PL1 and the first insulating substrate 10.

A second optical element OD2 is attached on an external surface 20B of the counter substrate CT, i.e., the external surface of the second insulating substrate 20 which forms the counter substrate CT by adhesives, etc. The second optical element OD2 is located on a display surface side of the liquid crystal display panel LPN, and controls the polarization state of emitted light from the liquid crystal display panel LPN. The second optical element OD2 includes a second polarization plate PL2 having a second polarizing axis AX2. Other optical elements such as retardation film may be arranged between the second polarization plate PL2 and the second insulating substrate 20. The first polarizing axis AX1 of the first polarization plate PL1 and the second polarizing axis AX2 of the second polarization plate PL2 are arranged in the Crossed Nichol relationship. In this case, one of the polarization plates is arranged so that the polarizing axis is set to the extending direction of the main pixel electrode PA, substantially parallel direction to the initial alignment direction, or substantially orthogonally crossing direction with the initial alignment direction.

Next, operation of a lineally polarized mode is explained in the liquid crystal display panel LPN with the above-mentioned structure.

At the time of non-electric field state (OFF), i.e., when potential difference (i.e., electric field) is not formed between the pixel electrode PE and the common electrode CE, the liquid crystal molecules LM of the liquid crystal layer LQ are initially aligned so that their long axes are aligned in parallel with the second direction Y in the X-Y plane as shown with a dashed line in FIG. 4A. The time of OFF corresponds to the initial alignment state, and the alignment direction of the liquid crystal molecule LM at the time OFF, i.e., the second direction Y corresponds to the initial alignment direction.

At the time of OFF, a portion of the backlight from the backlight BL penetrates the first polarization plate PL1, and enters into the liquid crystal display panel LPN. The backlight which entered into the liquid crystal display panel LPN is linearly polarized light which intersects perpendicularly with the first polarizing axis AX1 of the first polarization plate PL1. The polarization state of the linearly polarized light does hardly change when the backlight passes the liquid crystal layer LQ at the time OFF. For this reason, the linearly polarized light which penetrates the liquid crystal display panel LPN is absorbed by the second polarization plate PL2 which is arranged in the Crossed Nichol positional relationship with the first polarization plate PL1 (black display).

On the other hand, in case the potential difference (or electric field) is formed between the pixel electrode PE and the common electrode CE, i.e., at the time of ON, the lateral electric field (or oblique electric field) is formed in parallel with the substrates between the pixel electrode PE and the common electrode CE. The liquid crystal molecule LM is affected by the electric field between the pixel electrode PE and the common electrode CE, and the alignment state changes. That is, the long axes of the liquid crystal molecules rotate in the plane substantially in parallel to the X-Y plane. Thereby, transmissive regions in which the backlight can penetrate are formed between the pixel electrode PE and the common electrode CE.

In the embodiment shown in FIGS. 4A, 4B and 4C, in the upper half region between the pixel electrode PE and the third main common electrode CAL3 in the pixel PX, electric field is formed among the main pixel electrode PA, the first sub-pixel electrode PB1 and the second main common electrode CAL2, and among the main pixel electrode PA, the first sub-pixel electrode PB1 and the third main common electrode CAL3, respectively. Accordingly, the liquid crystal molecule LM mainly rotates clockwise to the second direction Y, and turns to the lower left in the figure. Furthermore, in the lower half region of the pixel PX, the electric field is formed among the main pixel electrode PA, the second sub-pixel electrode PB2 and the second main common electrode CAL2, and among the main pixel electrode PA, the second sub-pixel electrode PB2 and the third main common electrode CAL3, respectively. Accordingly, the liquid crystal molecule LM mainly rotates counterclockwise to the second direction Y, and turns to the upper left in the figure.

In the upper half region between the pixel electrode PE and the third main common electrode CAR3 in the pixel PX, electric field is formed among the main pixel electrode PA, the first sub-pixel electrode PB1 and the second main common electrode CAR2, and among the main pixel electrode PA, the first sub-pixel electrode PB1 and the third main common electrode CAR3, respectively. Accordingly, the liquid crystal molecule LM mainly rotates counterclockwise to the second direction Y, and turns to the lower right in the figure. Furthermore, in the lower half region of the pixel PX, the electric field is formed among the main pixel electrode PA, the second sub-pixel electrode PB2 and the second main common electrode CAR2, and among the main pixel electrode PA, the second sub-pixel electrode PB2 and the third main common electrode CAR3, respectively. Accordingly, the liquid crystal molecule LM mainly rotates clockwise to the second direction Y, and turns to the upper right in the figure.

Thus, in each pixel PX, at the time when the electric field is formed between the pixel electrode PE and the common electrode CE, the alignment direction of the liquid crystal molecule is divided into a plurality of directions with respect to the region in which the pixel electrode PE and the sub-common electrode CB overlap each other, and domains are formed corresponding to each direction. That is, a plurality of domains is formed in each pixel PX.

At the time of ON, the linearly polarized light which intersects perpendicularly with the first polarizing axis AX1 of the first polarization plate PL1 enters into the liquid crystal display panel LPN, and the polarization state changes when passing the liquid crystal layer LQ in accordance with the alignment state of the liquid crystal molecule LM. For this reason, at the time of ON, at least a portion of the backlight which passed the liquid crystal layer LQ penetrates the second polarization plate PL2 (white display).

According to this embodiment, the first semiconductor layer SC1 connected to the source line S1 and intersecting the gate line G1 is separated from the second semiconductor layer SC2 which counters the storage capacitance line C1 in the pixel PX. For this reason, as compared with the comparative example in which the first semiconductor layer SC1 is integrally formed with the second semiconductor layer SC2 in one, it becomes possible to reduce the formation area of the semiconductor layer. Moreover, the first contact portion PC1 contacting the first semiconductor layer SC1 is electrically connected with the contact portion PC2 contacting with the second semiconductor layer SC2 by the connection portion CN formed of transparent electric conductive material. For this reason, it becomes possible to reduce the formation area of the refractive metal material in one PX. Thereby, it becomes possible to reduce the undesirable reflection of outside light which enters toward the liquid crystal display panel LPN by the semiconductor layer or the metal material. According to the inventor's review, when reflectance of the outside light is made into 100% in a comparative example, the reflectance was able to be reduced to 80% in this embodiment. Furthermore, it becomes possible to enlarge the aperture area.

Moreover, according to this embodiment, since the sub-common electrode CB is arranged so as to overlap with the gate line G, undesirable leaked electric field from the gate line G can be shielded. The sub-common electrode CB functions as a gate shield electrode. Therefore, the influence by undesirable electric field in the region close to the gate line G is eased in the transmissive region, and it becomes possible to control degradation of display grace due to burn-in phenomenon.

Moreover, according to this embodiment, the array substrate AR includes two layers of main common electrodes (the first main common electrode CA1 and the second main common electrode CA2) facing the liquid crystal layer LQ in the circumference of each source line S, to which the same potential, i.e., the common potential is applied. The first main common electrode CA1 in the lower layer is arranged inside of the pixel rather than above the source line S. The second main common electrode CA2 in the upper layer is located right above the source line S2. Since the first main common electrode CA1 and the second main common electrode CA2 are set to the same potential, an equipotential surface is formed therebetween. The equipotential surface shields undesirable leaked electric field which directs to the liquid crystal layer LQ from the source line S arranged in the lower layer. That is, the first main common electrode CA1 and the second main common electrode CA2 can shield undesirable leaked electric field from the source line S, and can function as a source shield electrode. Thus, the influence by the leaked electric field from the source line S which adjoins the pixel electrode PE can be eased, and it becomes possible to control degradation of the display grace by a cross talk.

Moreover, while lateral electric field (or oblique electric field) required to control the alignment of the liquid crystal molecule between the main pixel electrode PA and the second main common electrode CA2, and between the main pixel electrode PA and the third main common electrode CA3 is formed at the time of ON in this embodiment, fringe electric field is also formed between the main pixel electrode PA and the sub-common electrode CB. In the X-Y plane, the fringe electric field is substantially in parallel to the above lateral electric field. For this reason, it becomes possible to control alignment disorder of the liquid crystal molecule LM near the gate line G, i.e., in the circumference of the sub-common electrode CB. Thereby, it becomes possible to improve transmissivity in the circumference of the gate line G, and also to improve the transmissivity in each pixel.

When the fringe electric field acts on the liquid crystal molecule, the alignment of the liquid crystal molecule is disordered, and it may become impossible to obtain desired transmissivity in the example explained here. However, it is possible to reduce the influence by the fringe electric field to the liquid crystal layer by making large the thickness of the fourth insulating film 14 formed of transparent resin material. For example, when forming the fourth insulating film 14 with the resin material, since it is preferable to form the fourth insulating film 14 with approximately 1 μm thickness, it becomes possible to raise more manufacturing yield than the case in which the fourth insulating film 14 is formed of the transparent non-organic materials.

Moreover, in this embodiment, while the first main common electrode CA1 is located in the region facing the aperture AP (transmissive region), the first main common electrode CA1 is formed of transparent electric conductive material. At the time of ON, the liquid crystal molecule LM located right above the first main common electrode CA1 is alignment controlled by electric field between the pixel electrode PE and the second main common electrode CA2, and between the pixel electrode PE and the third main common electrode CA3. Accordingly, the liquid crystal molecules LM above the first main common electrode CA1 also contribute to the display. That is, in this embodiment, while the first main common electrode CA1 is arranged in the aperture AP, the fall of the transmissivity in the aperture AP is not resulted, and high transmissivity is achieved.

At the time of ON, the liquid crystal molecule LM in the region which overlaps with the main pixel electrode PA, the second main common electrode CA2 and the third main common electrode CA3 maintains the same initial alignment state as the time of OFF (or the time of a black display) even at the time ON, and does not contribute to the display. For this reason, in case electrode widths of the second main common electrode CA2 and the third main common electrode CA3 are formed so as to be larger than the line width of the source line S, the region which runs off from the source line S does not contribute to the display. On the other hand, according to this embodiment, since the electrode widths of the second main common electrode CA2 and the third main common electrode CA3 are made smaller than the line width of the source line S, it becomes possible to expand the region in which the alignment of the liquid crystal molecule LM is controlled.

Moreover, according to this embodiment, the first main common electrode CA1 near the source line S is arranged in the position which is shifted from the region right above the source line S. For this reason, it becomes possible to control formation of the undesirable capacitance between the source line S and the first main common electrode CA1, and also to reduce the power consumption of the liquid crystal display device. Moreover, since the second main common electrode CA2 facing the source line S is located more apart from the source line S than the first main common electrode CA1, and has line width smaller than the source line S, it becomes possible to reduce the influence to the display by the capacitance formed therebetween.

Moreover, the liquid crystal molecule LM in the region which overlaps with the second main common electrode CA2 located right above the source line S or the region which overlaps with the third main common electrode CA3 located under the black matrix BM maintains the initial alignments state even at the time of ON. For this reason, even if assembling shift arises between the array substrate AR and the counter substrate CT, the leakage of undesirable electric field to adjoining pixels can be controlled. Therefore, even if it is a case where the colors of color filter CF differ between the adjoining pixels, it becomes possible to control generating of mixed colors. Moreover, even if it is a case where the liquid crystal display panel is viewed from an oblique direction, since the backlight does not penetrate the region which overlaps with the second main common electrode CA2 or the third main common electrode CA3, it becomes possible to control generating of mixed colors.

Moreover, according to this embodiment, it becomes possible to form a plurality of domains in one pixel. For this reason, a viewing angle can be optically compensated in the plurality of directions, and wide viewing angle can be attained.

Next, a second embodiment is explained.

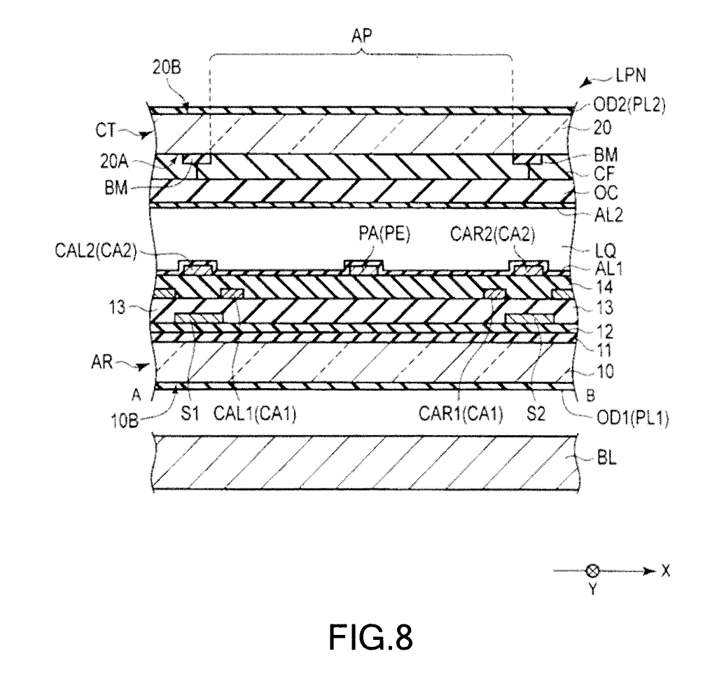

FIG. 8 is a cross-sectional view schematically showing a modified structure of the liquid crystal display panel LPN taken along line A-B shown in FIG. 2.

The second embodiment shown in FIG. 8 is different from the first embodiment shown in FIG. 5 in that the counter substrate CT is not equipped with the third common electrode. In addition, since other structures are the same as those of the first embodiment shown in FIG. 5, detailed explanation is omitted.

That is, the substantially entire surface of the overcoat layer OC facing the array substrate AR is covered with the second alignment film AL2 in the counter substrate CT.

According to the second embodiment, since the liquid crystal molecule in the transmissive domain is alignment controlled by electric field formed between the pixel electrode PE and the second main common electrode CA2, the liquid crystal molecule contributes to the display.

Also in the second embodiment, the same effect as the first embodiment is acquired.

In addition, although the embodiments explain about the case where the initial alignment direction of the liquid crystal molecule LM is in parallel to the second direction Y, the initial alignment direction of the liquid crystal molecule LM may be a direction which obliquely crosses the second direction Y.

Moreover, although the embodiments explain about the case where the liquid crystal layer LQ is constituted by liquid crystal materials with positive dielectric constant anisotropy (positive type), the liquid crystal layer LQ may be constituted by liquid crystal materials with negative dielectric constant anisotropy (negative type).

Moreover, in the embodiments, the first contact portion PC1 contacting with the first semiconductor layer SC1 is electrically connected with the second contact portion PC2 contacting with the second semiconductor layer SC2 by the connection portion CN each other. However, it may be possible that the connection portion CN on the third insulating film 13 contacts the first semiconductor layer SC1 and the second semiconductor layer SC2 directly, and electrically connects the first semiconductor layer SC1 and the second semiconductor layer SC2 without providing the first contact portion PC1 and the second contact portion PC2.

Moreover, in the embodiments, it is possible not to provide the sub-common electrode as long as undesirable leaked electric field from the gate line G does not influence to the alignment of the liquid crystal molecule. Moreover, as long as undesirable leaked electric field from the source line S does not influence to the alignment of the liquid crystal molecule, it is possible not to provide the first main common electrode.

As explained above, according to the embodiments, it becomes possible to supply the liquid crystal display device which can control degradation of display grace.

While certain embodiments have been described, these embodiments have been presented by way of example only, and are not intended to limit the scope of the inventions. In practice, the structural and method elements can be modified without departing from the spirit of the invention. Various embodiments can be made by properly combining the structural and method elements disclosed in the embodiments. For example, some structural and method elements may be omitted from all the structural and method elements disclosed in the embodiments. Furthermore, the structural and method elements in different embodiments may properly be combined. The accompanying claims and their equivalents are intended to cover such forms or modifications as would fall with the scope of the inventions.

What is claimed is:

1. A liquid crystal display device comprising:
a first substrate including;
a first semiconductor layer,
a second semiconductor layer apart from the first semiconductor layer,
a first insulating film covering the first semiconductor layer and the second semiconductor layer,
a gate line arranged on the first insulating film and extending in a first direction so as to cross the first semiconductor layer,
a second insulating film covering the gate line,
a source line arranged on the second insulating film and extending in a second direction orthogonally crossing the first direction, the source line contacting the first semiconductor layer,
a first contact portion formed in an island shape on the second insulating film and contacting the first semiconductor layer,
a second contact portion formed in an island shape on the second insulating film and contacting the second semiconductor layer,
a third insulating film covering the source line, the first contact portion and the second contact portion,
a connection portion arranged on the third insulating film and extending in the second direction for electrically coupling the first contact portion and the second contact portion, the connection portion being formed of transparent conductive material,
a sub-common electrode arranged on the third insulating film and extending in the first direction, the sub-common electrode facing the gate line and crossing the source line,
a first main common electrode arranged on the third insulating film and electrically coupled with the sub-common electrode so as to extend in the second direction along the source line,
a fourth insulating film covering the connection portion, the sub-common electrode and the first main common electrode,
a second main common electrode arranged on the fourth insulating film and extending in the second direction so as to face the source line, the second main common electrode being set to the same potential as the first main common electrode, and
a pixel electrode including a main pixel electrode arranged on the fourth insulating film, passing a region facing the connection portion and extending in the second direction so as to be apart from the second main common electrode, the pixel electrode being electrically coupled to the connection portion, and
a first alignment film covering the second main common electrode and the pixel electrode,
a second substrate facing the first substrate; and
a liquid crystal layer held between the first substrate and the second substrate.

2. The liquid crystal display device according to claim 1, wherein the second substrate includes a third main common electrode extending in the second direction so as to face the second main common electrode and set to the same potential as the second main common electrode, and a second alignment film covering the third main common electrode.

3. The liquid crystal display device according to claim 1, wherein
the first semiconductor layer includes;
a first straight line portion extending in the second direction so as to face the source line, contacting the source line at one end of the first straight line portion and crossing the gate line,
a second straight line portion connected with the other end of the first straight line portion and extending in the first direction in parallel to the gate line, and
a third straight line portion connected with the second straight line portion at one end of the third straight line portion and extending in the second direction so as to face the main pixel electrode, the third straight line portion crossing the gate line and contacting the first contact portion at the other end of the third straight line portion, and
the second semiconductor layer is located on the same line as the third straight line portion.

4. The liquid crystal display device according to claim 1, wherein
the first substrate includes a first storage capacitance line and a second storage capacitance line extending in the first direction respectively, and
the gate line is arranged in an intermediate portion between the first and second storage capacitance lines.

5. The liquid crystal display device according to claim 4, wherein the first substrate includes;
a first sub-pixel electrode arranged on the first storage capacitance line and electrically coupled with one end of the main pixel electrode, the first sub-pixel electrode extending in the first direction, and
a second sub-pixel electrode arranged on the second storage capacitance line and electrically coupled with the other end of the main pixel electrode, the second sub-pixel electrode extending in the first direction.

6. The liquid crystal display device according to claim 1, wherein
the sub-common electrode, the first main common electrode and the connection portion are formed of transparent materials.

7. The liquid crystal display device according to claim 1, wherein
the first main common electrode is arranged on the main pixel electrode side rather than an overlapping portion with the source line, and
the second main common electrode has electrode width smaller than line width of the source line, and is formed in a position overlapping with the source line.

8. A liquid crystal display device comprising:
a first substrate including;
a first semiconductor layer,
a second semiconductor layer apart from the first semiconductor layer,
a first insulating film covering the first semiconductor layer and the second semiconductor layer,
a gate line arranged on the first insulating film and extending in a first direction so as to cross the first semiconductor layer,
a second insulating film covering the gate line,
a source line arranged on the second insulating film and extending in a second direction orthogonally crossing the first direction, the source line contacting the first semiconductor layer,
a third insulating film covering the source line,
a connection portion arranged on the third insulating film and extending in the second direction for electrically coupling the first semiconductor layer and the second semiconductor layer,
a fourth insulating film covering the connection portion,
a main common electrode arranged on the fourth insulating film and extending in the second direction so as to face the source line,
a pixel electrode including a main pixel electrode arranged on the fourth insulating film, passing a region facing the connection portion and extending in the second direction so as to be apart from the main common electrode, the pixel electrode being electrically coupled to the connection portion, and
a first alignment film covering the main common electrode and the pixel electrode,
a second substrate facing the first substrate; and
a liquid crystal layer held between the first substrate and the second substrate.

9. The liquid crystal display device according to claim 8, wherein
the first semiconductor layer includes;
a first straight line portion extending in the second direction so as to face the source line, contacting the source line at one end of the first straight line portion and crossing the gate line,
a second straight line portion connected with the other end of the first straight line portion and extending in the first direction in parallel to the gate line, and
a third straight line portion connected with the second straight line portion at one end of the third straight line portion and extending in the second direction so as to face the main pixel electrode, the third straight line portion crossing the gate line and electrically coupled with the connection portion at the other end of the third straight line portion, and
the second semiconductor layer is located on the same line as the third straight line portion.

10. The liquid crystal display device according to claim 8, wherein
the first substrate includes a first storage capacitance line and a second storage capacitance line extending in the first direction respectively, and
the gate line is arranged in an intermediate portion between the first and second storage capacitance lines.

11. The liquid crystal display device according to claim 10, wherein the first substrate includes;
a first sub-pixel electrode arranged on the first storage capacitance line and electrically coupled with one end of the main pixel electrode, the first sub-pixel electrode extending in the first direction, and
a second sub-pixel electrode arranged on the second storage capacitance line and electrically coupled with the other end of the main pixel electrode, the second sub-pixel electrode extending in the first direction.

12. The liquid crystal display device according to claim 8, wherein
the main common electrode and the connection portion are formed of transparent materials.

13. A liquid crystal display device comprising:
a first substrate including;
a first semiconductor layer,
a second semiconductor layer apart from the first semiconductor layer,
a first insulating film covering the first semiconductor layer and the second semiconductor layer,
a gate line arranged on the first insulating film and extending in a first direction so as to cross the first semiconductor layer,
first and second storage capacitance lines arranged on the first insulating film and extending in the first direction, the gate line being located in an intermediate portion between the first and second storage capacitance lines,
a second insulating film covering the gate line,
first and second source lines arranged on the second insulating film and extending in a second direction orthogonally crossing the first direction, the first source line contacting the first semiconductor layer,
a third insulating film covering the first and second source lines,
a connection portion arranged on the third insulating film and extending in the second direction for electrically coupling the first semiconductor layer and the second semiconductor layer,
a fourth insulating film covering the connection portion,
a main common electrode arranged on the fourth insulating film and extending in the second direction so as to face the first and second source lines,
a pixel electrode including a main pixel electrode arranged on the fourth insulating film, passing a region facing the connection portion and extending in the second direction so as to be apart from the main common electrode, the pixel electrode being electrically coupled to the connection portion, and
a first alignment film covering the main common electrode and the pixel electrode,
a second substrate facing the first substrate; and
a liquid crystal layer held between the first substrate and the second substrate, wherein
the first semiconductor layer includes;
a first straight line portion extending in the second direction so as to face the first source line, contacting the first source line at one end of the first straight line portion and crossing the gate line,
the first straight line portion under the gate line forms a first channel region of a first switching element,
a second straight line portion connected with the other end of the first straight line portion and extending in the first direction in parallel to the gate line,
a third straight line portion connected with the second straight line portion and extending in the second direction so as to face the main pixel electrode, the third straight line portion crossing the gate line and electrically coupled with the connection portion at the other end of the third straight line portion,
the third straight line portion under the gate line forms a channel region of a second switching element.

14. The liquid crystal display device according to claim 13, wherein the first, second, third straight line portions of the first semiconductor layer form a U shape.

15. The liquid crystal display device according to claim 13, wherein the first substrate includes;
a first sub-pixel electrode arranged on the first storage capacitance line and electrically coupled with one end of the main pixel electrode, the first sub-pixel electrode extending in the first direction, and
a second sub-pixel electrode arranged on the second storage capacitance line and electrically coupled with the other end of the main pixel electrode, the second sub-pixel electrode extending in the first direction.

16. The liquid crystal display device according to claim 13, wherein
the main common electrode and the connection portion are formed of transparent materials.
